(19) United States
(12) Patent Application Publication
(10) Pub. No.: US 2026/0010554 A1
(43) Pub. Date: Jan. 8, 2026

(54) Auto-Learning Chatbot Scenarios

(71) Applicant: Text S.A., Wroclaw (PL)

(72) Inventor: Dariusz Zabrzenski, Kamieniec Zabkowicki (PL)

(73) Assignee: Text S.A., Wroclaw (PL)

(21) Appl. No.: 18/764,424

(22) Filed: Jul. 5, 2024

(51) Int. Cl. G06F 16/33; G06F 16/335; G06F 16/35; G06F 16/383; G06F 40/205

(52) U.S. Cl. CPC G06F 16/3344; G06F 16/337; G06F 16/35; G06F 16/383; G06F 40/205

(57) ABSTRACT

A system and method for analyzing collected content from conversations between agents and end users to identify patterns and generate automated responses is disclosed. The system includes a database for storing collected content, a processing module for classifying and analyzing content, a communication interface for retrieving data via an API, and an output module for providing generated responses to users. The processing module employs various techniques, including Natural Language Processing (NLP) methods such as language detection, sentence segmentation, and part-of-speech tagging, as well as Machine Learning (ML) techniques like Naive Bayesian Classifier and clustering algorithms based on cosine similarity. The system can classify conversation content to determine if a message is a question, analyze content based on assumptions such as user-rated helpfulness, and transform the content into vector form using sentence-transformer models. It clusters the content and generates responses by identifying the most relevant response within each cluster.

### BACKGROUND OF THE INVENTION

### Field of the Invention

The present invention relates to the general field of chatbots and more particularly to automatic learning chatbot scenarios based upon retrieved data from aggregated conversations.

### Description of Related Art

Chatbots are computer programs which, when run on a computer, interact with human users so as to stimulate and process a human interaction or conversation. Such may be through written and/or spoken words. A chatbot may operate locally on the user's computer and/or remotely engaging the user online. An intention of a chatbot is enable a user to interact with a digital device through communication that simulates human-to-human communication. Chatbots can be as simple as rudimentary programs that answer a simple query with a single-line response, or as sophisticated as digital assistants that learn and evolve to deliver increasing levels of personalization as they gather and process information.

Chatbots are driven by artificial intelligence (AI), automated rules, natural-language processing (NLP), and machine learning (ML). With this, chatbots process data to deliver responses to requests of all kinds. They come in a variety of forms and functionalities, including but not limited to rule-based chatbots, keyword recognition-based chatbots, menu-based chatbots, contextual or intelligent chatbots, hybrid chatbots, and voice-enabled chatbots. The present invention is not limited to any specific type of chatbot with application to any specific chatbot form and functionality being within the purview of the skilled person.

Generally, there are two main types of chatbots. A first type are task-oriented or declarative chatbots which are single-purpose programs that focus on performing one function. Using rules, NLP, and very little ML, they generate automated but otherwise conversational responses to user inquiries. Interactions with these types of chatbots are highly specific and structured and are most applicable to support and service functions such as automated interactive frequently asked questions. Task-oriented chatbots can also handle common questions, such as queries about hours of business or simple transactions that do not involve a variety of variables that require more complex considerations and analysis. Though they do use NLP, primarily so that end users may experience these chatbots in essentially conversational ways, these first type of chatbots capabilities are basic. These are also currently the most commonly used chatbots. A second type are data-driven and predictive or conversational chatbots. These are often referred to as virtual assistants or digital assistants and are more sophisticated than the first type of chatbots, namely, more, interactive and personalized rather than simply task-oriented.

These second types of chatbots are contextually aware and leverage natural-language understanding (NLU), NLP, and ML so as to essentially learn as they go. They apply predictive intelligence and analytics to enable personalization based on user profiles and past user behavior. Digital assistants can learn a user's preferences over time, provide recommendations, as well as anticipate user needs. In addition to monitoring data and intent, these second type of chatbots can proactively initiate conversations. Still further, advanced digital assistants are also able to connect several single-purpose chatbots functionally so as to pull disparate information from each of them, and then combine this information to perform a task while still maintaining context.

Common to all types of chatbots is the need to program or train them for a particular task. While some programming may be done manually, there is a continual need in the art to enable chatbots to take up at least a portion of their training so as to relieve the chatbot owner of such burdens while enhancing the chatbot functionality, applicability and complexity.

The present invention enables the chatbot learning process and further the creation of chatbot scenarios based upon data retrieved from prior conversations performed via designated communication channels. For example, rule-based chatbots (also command-based, keyword, or transactional) communicate using predefined answers. Accordingly, in for example using the aforementioned, an objective of the presently disclosed invention is to create automated chatbot scenarios based upon the data owned by the embodiment user.

In typical chatbot solutions, scenarios and conditions that trigger replies are usually provided manually by the user. Current state of the art enables a user to prepare a set of such conditions, such as: the user makes a purchase, the user has a credit card connected to the system, this then assigns the user to a particular group of scenarios, and then, based on the natural language processing, respond to the messages that the user sends, via chat widget, to the chatbot. Nevertheless, the set of responses sent by the chatbot are usually manually created by the user. Certain other state of the art solutions enable the user of the aforementioned embodiment to have suggested responses based on the most efficient responses that are already available in the archive of the communication.

The present inventive solution benefits from a dataset collected by the user of the embodiment as per communications with end-users. If, for example, an e-commerce shop offers a chat customer service (real-time communication channels), the communication with end users, based on chat threads, is usually saved in the data archives for the purpose of further revision thus making the same available to the present invention.

An additional benefit arising from the use of the presently disclosed invention is the automated creation of the communication scenarios for a chatbot without the need for manual, human-based work, thereby increasing production efficiency. At the moment, manual creation of the chatbot scenarios remains a time-consuming task, while, at the same time, use of generic scenarios may be less tailored for a specific group of end-users. Further to the present invention, the provided solutions enable training of the chatbot on a user's own set of data. It further enables group data to provide particular and relevant scenarios for distinct groups of end users according to their characteristics and needs.

### BRIEF SUMMARY OF THE INVENTION

The present invention is directed to a system and method that enables the analysis of collected content in order to search for patterns. Such patterns may be based on a plurality of assumptions, including:
selection of the most appropriate answers where the end-user rated the response as helpful;
selection of the answers after which the user closed the communication (having the assumption that the answer was helpful); and
selection of the answers after which the response from the user is immediate.

Other assumptions, as may be envisioned by the skilled person, may be employed in addition to or as a substitution for any of the aforementioned. The above-presented list is a reference to examples which may be the denominator based upon which communication threads for which the learning process may be performed.

The outcome of the communication, also referred to as the conversation, may be only one classifying factor. The other element that remains important to providing a potential for learning by the chatbot, as based upon the collected data, is the frequency of certain asked questions. It remains beneficial, from the perspective of research, to sample creation to perform learning processes on the data sets that are frequent from the perspective of the user of the embodiment, due to the ability to analyze multiple communication scenarios.

A set of input data, also referred to as conversations, is processed accordingly, namely, it is converted into a form that allows extraction of some of the most common questions along with the generation of answers to them. Here, input data refers to a set of conversations between an agent and an end user.

The instant learning process, based on the archives of the user of the embodiment's communication with the end-users starts with the collection of data. An embodiment of the present invention enables server infrastructure with a database configured and arranged to communicate directly with the instant communication channel at least via API. Based on the individual needs of the embodiment user, the data may be either copied from the main database of the instant communication provider or the actions described herein may be implemented directly on the database and infrastructure of the instant communication provider as the logic steps to be implemented directly into the system.

Furthermore, the disclosed invention may perform method steps and further use the storage for the system elements for both cloud storage and on-premises physical storage. The data collected as the training sample may be user in either or all of:
a training sample for the language model as AI that further enables the system to accomplish tasks that typically necessitate human reasoning, such as comprehending human language, managing dialogues, decision-making, and learning; including enrichment of data with aspects as data analysis, speech recognition, language translation, linguistics, neuroscience;
Machine Learning (ML) implementation that allows the system to identify patterns in user input, make decisions, and learn from past conversations;
Natural Language Processing (NLP) that enables detection of behavioral patterns of the user communicating via chat widget; and
Sentiment assessment including emotional analysis of the user's behavior.

Each of the above-disclosed methods may be implemented on the extracted data sets by the user of an embodiment of the present invention to provide more efficient scenario-building in an automated manner. Furthermore, to ensure proper functioning of offered scenarios, the user of the embodiment of the invention is provided with the supervision possibility where the user can view and evaluate each scenario element as well as preview scenarios statistics.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts a system architecture for enabling the analysis of collected content from communication channels and chat threads to generate automated responses;

FIG. 2 depicts a detailed scheme of the initial steps of data collection, processing, and sentiment analysis to generate a suggested response;

FIG. 3 depicts expanded scheme on the data processing and sentiment analysis stages, incorporating advanced models like SBERT and MiniLM for embedding and similarity measurements; and

FIG. 4 depicts process involving data collection, processing, sentiment analysis, sentence clustering, semantic matching, response modeling, and pattern analysis to generate and refine suggested responses.

The figures are merely schematic representations and serve only to explain the invention. Identical or similarly acting elements are consistently provided with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

The embodiment of the invention enables retrieving data from the chatbot system to further facilitate data clustering and classification for the purpose of creating a learning sample. This process leverages advanced natural language processing (NLP) techniques and machine learning (ML) models to ensure accurate and efficient data handling. The method steps begin with the initial classification of the data, namely, content classification. An intention of this first step in input processing is to classify the content contained in a conversation. The conversation is analyzed to identify each message, which is then tagged by a first model to determine whether the sentiment of the message is or is not a question.

This tagging process utilizes sophisticated sentiment analysis algorithms that assess the emotional tone and intent of the message. Next, the system matches the most adequate response to the given sentiment, employing a response matching algorithm that considers historical data and contextual relevance. Accordingly, subsequent mechanisms can now clearly identify data which is suitable for clustering, allowing for the grouping of similar messages. This clustering is based on various parameters, including semantic similarity and response patterns, enabling the creation of comprehensive learning samples that enhance the chatbot's ability to generate accurate and contextually appropriate responses in future interactions.

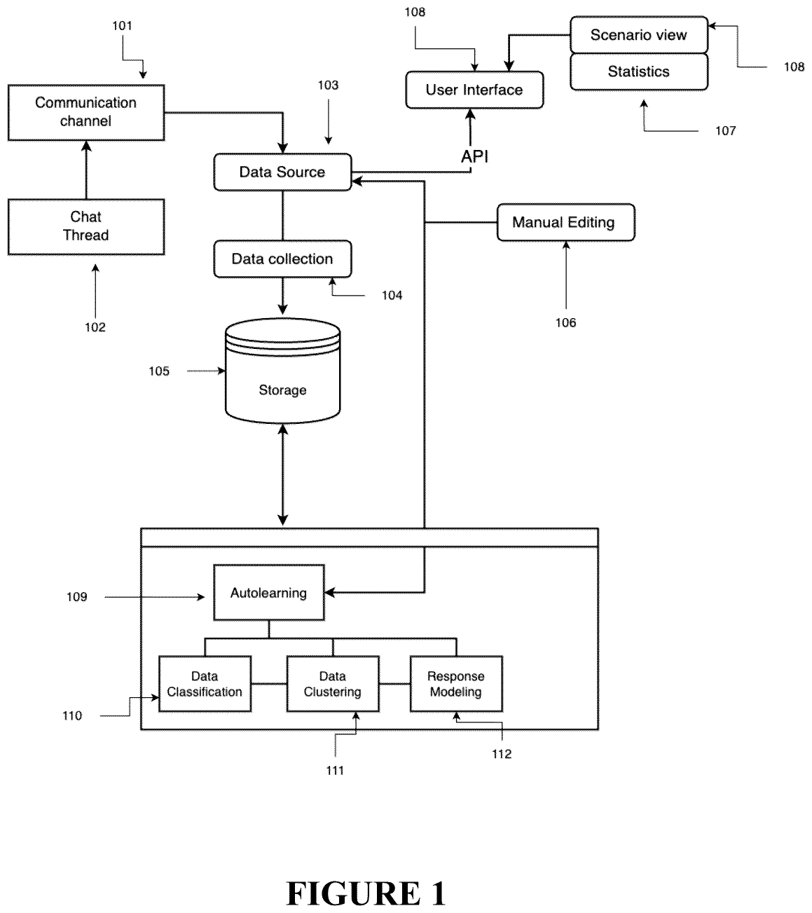

FIG. 1 illustrates a system architecture for enabling the analysis of collected content to search for patterns and generate automated responses. The system includes various data sources (103) such as chat threads (102) and communication channels (101), which provide the collected content comprising conversations between an agent and an end user. The data source (103) collects data and sends it to storage (105). The data is then processed by an autolearning module (109), which includes several components: data classification (110), data clustering (111), and response modeling (112). These components work together to classify the content of conversations, identify patterns, and generate responses. The processed data is sent to the user interface (107), which includes a scenario view (108) and statistics (108) for users to evaluate and adjust the generated scenarios. The system also includes a manual editing interface (106) for user intervention and adjustments. The entire system communicates via an API to ensure seamless data retrieval and processing.

A suitable model that may be used to classify questions, is one which is able to react according to the type of sentiment, its length and the factors that influence whether it should be classified as a question. The entire mechanism is divided into several stages:
determining the length of the input text and the number of sentences in a given sentence;
language detection by means of a model analyzing the language of the sentences;
division of sentences into sentence parts using Natural Language Processing methods;
classification of sentences using Naive Bayesian Classifier; and
depending on the division of sentences:
using the method of Bayesian classifier, or
using a model that classifies the probability of sentences by analyzing the parts of the sentence.

This adaptability ensures that the model can handle a wide variety of conversational contexts and nuances. These stages work in concert to ensure accurate and efficient classification, thereby improving the overall performance of the chatbot system in understanding and responding to user queries

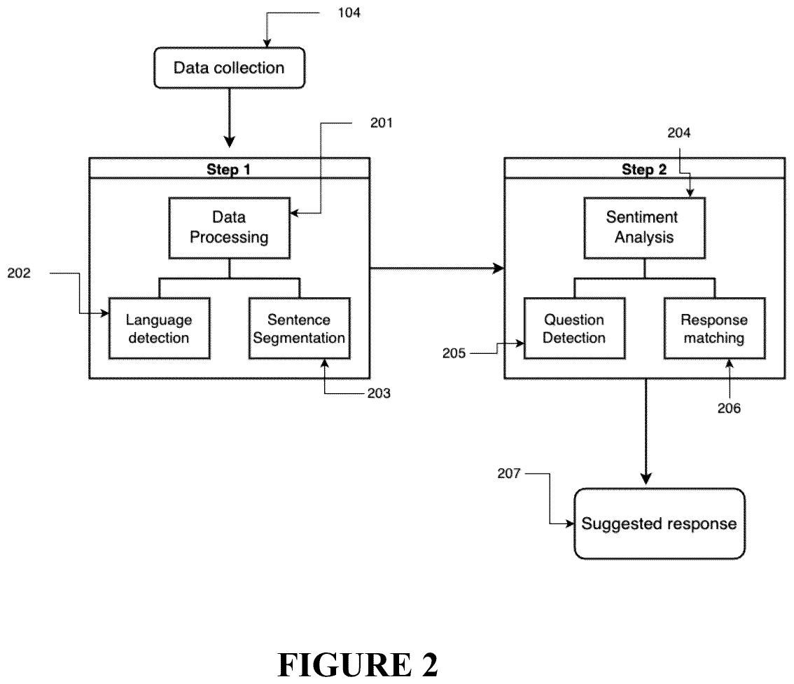

After the performance of the above-presented steps the data set is ready for data clustering. FIG. 2 illustrates a detailed process for analyzing collected content to generate suggested responses. The process begins with data collection (104), which gathers the conversation data. This data is then fed into the first step (201), which involves data processing (202). Data processing includes language detection (202) and sentence segmentation (203), where the collected content is analyzed to detect the language used and to segment the sentences accordingly. Next, the processed data moves to the second step (204), which involves sentiment analysis (205). Sentiment analysis comprises two main tasks: question detection (206) and response matching (207). Question detection identifies whether a given sentiment or message in the conversation is a question, while response matching finds the most appropriate response for the identified question. Finally, the output of the sentiment analysis is a suggested response (207), which is generated based on the identified patterns and matched responses. This suggested response is then provided for further use, such as being sent to the end user or being reviewed and adjusted by a human agent.

Subsequently, method steps enable data clustering, and precisely, to properly cluster the processed input, define a similarity function between two sentences. To do this, a numerical representation of sentences is obtained. Furthermore, the definition of sentence and clustering process includes grouping sentences by cluster size and classification of sentences with cosine similarity greater than the predefined threshold t.

The present invention is not limited to any particular embedding technique. For purposes of non-limiting explanation, the Sentence-BERT (SBERT) model is applied as disclosed by FIG. 2. SBERT is a modification of the pre-trained BERT network, which uses the structures of the corresponding networks to obtain embeddings of sentences with semantic meaning that can be compared using cosine similarity. The application of SBERT results in the matrix of sentences divided into categories of grouped data including their level of similarity.

The instant method continues with reference to the embedding of input data that allows the user to transform a set of already classified content into vector form. An example model that can be used for data embedding is all-MiniLM-L6-v2 which refers to a sentence-transformer model: it maps sentences and paragraphs to a 384 dimensional dense vector space and can be used for tasks like clustering or semantic search. After embedding the input data, a data clustering process is executed.

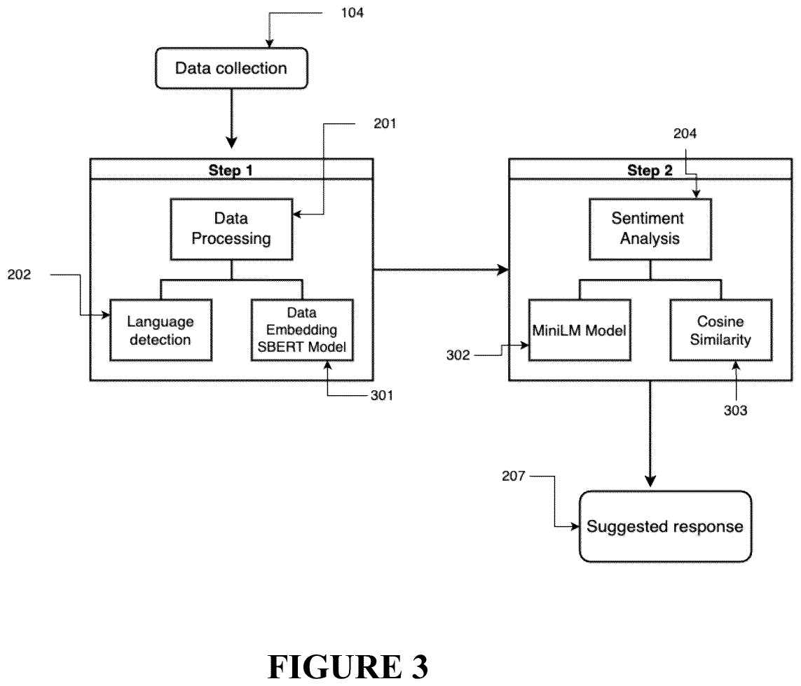

FIG. 3 discloses a detailed process for analyzing collected content to generate suggested responses. The process begins with data collection (104), which gathers the conversation data. This data is then fed into the first step (201), which involves data processing (202). Data processing includes language detection (202) and data embedding using the SBERT model (301), where the collected content is analyzed to detect the language used and to embed the data into vector form. Next, the processed data moves to the second step (204), which involves sentiment analysis (205). Sentiment analysis comprises two main tasks: using the MiniLM model (302) and cosine similarity (303). The MiniLM model helps in understanding the semantic meaning of the sentences, while cosine similarity measures the similarity between sentences to identify patterns and relationships. Finally, the output of the sentiment analysis is a suggested response (207), which is generated based on the identified patterns and matched responses. This suggested response is then provided for further use, such as being sent to the end user or being reviewed and adjusted by a human agent.

After the data is embedded to an input, a clustering algorithm may be applied. The embodiment of the invention discloses the clustering algorithm that further comprises:
at the start, comparing the similarities of all sentences with all other sentences by calculating the pairwise cosine similarities of sentence embeddings;
for each sentence, selecting all other sentences that have a cosine similarity score greater than a predefined threshold t; and
then sorting all sentences by cluster size.

The first sentence in each cluster is the most central sentence of that cluster.

The final result of the previous stage is a set of classified data in the form of clusters. This data leads to execution of a next method step, namely, modeling the responses to the classified sentences. The modeling shall be constructed in line with the following elements. The final outcome of the data clustering and assessment is the preparation of a data set enabling response modeling.

The final step of the disclosed method is to model the responses for the sentences contained in the cluster. The response may be a combination of a number of signs and contents, it may include textual content, audiovisual content or links depending on the data collected in the training sample. When modeling the input data each sentiment had a central answer recorded to provide more adequate addressing of the sentiment of the user and fit to the behavioral analysis of the user reaction to a particular response. This means that there could have been X similar questions and Y similar answers in the input data set.

With the help of semantic matching, the so-called central answer is obtained, which occurs most frequently in the given input data set and has the highest probability index of use in the next conversation between the agent and the end user.

The entire data modeling algorithm allows the user of the embodiment to: Search for the central answer for a given sentence in a cluster-it further refers to the process of identifying the most relevant and accurate response within a group of potential answers for a specific input sentence. This embodiment of the invention utilizes clustering techniques to organize and group similar sentences or utterances together. These clusters can contain multiple candidate responses that could potentially answer a user's query. However, to provide the most appropriate answer, the invention needs to determine which response within the cluster is the central or most suitable one. The search for the central answer involves analyzing the input sentence and comparing it with the sentences in the cluster. The chatbot may use various algorithms or methods, such as natural language processing (NLP) techniques, semantic similarity calculations, or machine learning models, to assess the relevance and accuracy of each response. It aims to select the response that best addresses the user's query and provides the most efficient information.

The entire data modeling algorithm further allows the user of the embodiment to: Look for similarity between clusters, it may happen that in the extraction process the clusters are similar enough to match the same central answer between 2 clusters. In this case, the next step is to merge the clusters. It further refers to the process of identifying similarities or common patterns across different groups of sentences or utterances. Instead of focusing on individual sentences within a cluster, this approach aims to find similarities between clusters themselves. In the embodiment of the invention learning process, clustering techniques are used to group similar sentences or utterances together based on their content or context. However, these clusters can vary in terms of the specific topics or themes they represent. By comparing the clusters and searching for similarities, this embodiment of the invention can gain a broader understanding of the underlying patterns or topics within the data. To find similarity between clusters, various methods can be used, such as measuring the overlap of keywords or analyzing the semantic relationships between the sentences within each cluster. Machine learning algorithms, such as clustering algorithms or topic modeling techniques, may also be utilized to identify common patterns across different clusters. By identifying similarities between clusters, an embodiment of the invention can improve the ability to categorize and understand different types of user queries or inputs. This can help the chatbot provide more accurate and relevant responses by leveraging knowledge from similar clusters to address user queries that may not have been encountered before. It can also assist in organizing the data archives including knowledge base and refining its understanding of various topics or domains and leading to more adequate responses.

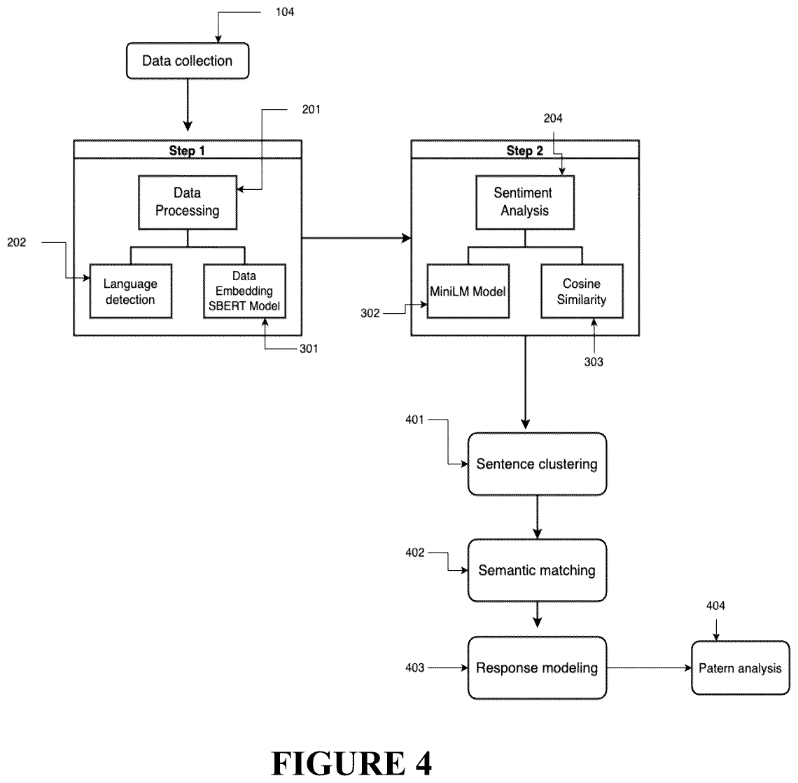

FIG. 4 shows a process for analyzing collected content to generate suggested responses through multiple stages. The process begins with data collection (104), which gathers conversation data. This data is then fed into the first step (201), which involves data processing (202). Data processing includes language detection (202) and data embedding using the SBERT model (301), where the collected content is analyzed to detect the language used and to embed the data into vector form. Next, the processed data moves to the second step (204), which involves sentiment analysis (205). Sentiment analysis utilizes the MiniLM model (302) to understand the semantic meaning of the sentences and cosine similarity (303) to measure the similarity between sentences to identify patterns and relationships.

Following sentiment analysis, the process continues with sentence clustering (401), where similar sentences are grouped together. Semantic matching (402) is then performed to identify the most relevant and accurate responses within each cluster. The response modeling (403) phase uses the clustered and matched data to generate appropriate responses. The final stage is pattern analysis (404), where the identified patterns and generated responses are analyzed to refine and improve future interactions. The output of this entire process is a suggested response (207), which is generated based on the identified patterns and matched responses. This suggested response is then provided for further use, such as it being sent to the end user or being reviewed and adjusted by a human agent.

With this approach, the final data contains a data model containing the cluster's subject matter—for example, a question about pricing, a set of sentences corresponding to the cluster, and a central answer.

Consequently, the answers are fully based on the communication of particular clusters that may be translated into the particular group of end-users. The process of learning may be repeated upon change and depending on the implementation, the update of such clusters may be triggered in an automated manner periodically. Furthermore, the offered solution enables a combination of scenarios created automatically based on the collected and analyzed data and manually to ensure flexibility for the user of the embodiment.

The end result allows and otherwise enables learning of the LLM model (Language Models), which is successively transformed into a model that represents a specific chatbot created by a user of the embodiment of the invention. As a consequence, the Language Model, which is a machine learning model that understands and generates human-like text and can be trained on a large dataset to learn patterns, context, and generate coherent responses remains responsible for the assessment of the clustered data and potentially generated responses. The fact that the user is in charge of the selection of data seats further supports tailor-made solutions for a particular group of recipients (end-users).

Since the devices and methods described in detail above are examples of embodiments, they can be modified to a wide extent by a person skilled in the art without departing from the scope of the invention. In particular, the mechanical arrangements and the proportions of the individual elements to one another are merely exemplary.

1. A system for enabling the analysis of collected content to search for patterns and generate automated responses, the system comprising:
a database configured to store collected content, wherein the collected content comprises conversations between an agent and an end user;
a processing module configured to:
classify the content of the conversations to determine whether the sentiment of a message is a question;
analyze the classified content based on a plurality of assumptions, including selection of the most appropriate answers where the end-user rated the response as helpful, selection of the answers after which the user closed the communication, and selection of the answers after which the response from the user is immediate;
transform the classified content into vector form using a sentence-transformer model;
cluster the vectorized content based on a similarity function between sentences;
generate responses for the clustered content by identifying the most relevant and accurate response within each cluster;
an output module configured to provide the generated responses to the user; and
a communication interface configured to retrieve data from an instant communication channel via an API.

2. The system according to claim 1, wherein the processing module further comprises identifying patterns in user input using machine learning techniques to make decisions and learn from past conversations.

3. The system according to claim 1, wherein the processing module further comprises detecting behavioral patterns of the user using Natural Language Processing methods.

4. The system according to claim 1, wherein the processing module further comprises performing sentiment assessment to analyze the emotional tone of the user's behavior.

5. The system according to claim 1, wherein the assumptions include at least one of:
selection of the most appropriate answers where the end-user rated the response as helpful;
selection of the answers after which the user closed the communication; and
selection of the answers after which the response from the user is immediate.

6. The system according to claim 1, further comprising storage means for storing system elements on both cloud storage and on-premises physical storage.

7. The system according to claim 1, further comprising a user interface configured to allow a user to view and evaluate scenario elements and preview scenario statistics.

8. The system according to claim 1, wherein the machine learning techniques include the use of Naive Bayesian Classifier and clustering algorithms based on cosine similarity.

9. The system according to claim 5, wherein upon assuming an answer is helpful, the system updates the dataset to enhance the likelihood of selecting similar responses in future interactions.

10. A method for enabling the analysis of collected content to search for patterns and generate automated responses, the method comprising:
collecting a set of input data comprising conversations between an agent and an end user;
classifying the content of the conversations to determine whether the sentiment of a message is a question;
analyzing the classified content based on a plurality of assumptions;
transforming the classified content into vector form using a sentence-transformer model;
clustering the vectorized content based on a similarity function between sentences;
generating responses for the clustered content by identifying the most relevant and accurate response within each cluster; and
providing the generated responses to the user.

11. The method according to claim 10, further comprising identifying patterns in user input using machine learning to make decisions and learn from past conversations.

12. The method according to claim 10, further comprising detecting behavioral patterns of the user using Natural Language Processing methods.

13. The method according to claim 10, further comprising performing sentiment assessment to analyze the emotional tone of the user's behavior.

14. The method according to claim 10, further comprising updating the dataset upon assuming an answer is helpful to enhance the likelihood of selecting similar responses in future interactions.

15. The method according to claim 10, further comprising allowing a user to view and evaluate scenario elements and preview scenario statistics.

16. The method according to claim 10, wherein the Natural Language Processing methods include language detection, sentence segmentation, and part-of-speech tagging.

17. The method according to claim 10, wherein the machine learning techniques include the use of Naive Bayesian Classifier and clustering algorithms based on cosine similarity.
